(19) United States
(12) Patent Application Publication
(10) Pub. No.: US 2017/0221081 A1
(43) Pub. Date: Aug. 3, 2017

(54) SYSTEM AND METHOD FOR USE IN A SECURE PERSONAL DATA MARKETPLACE

(71) Applicant: PCMS Holdings, Inc., Wilmington, DE (US)

(72) Inventors: Ville J. Ollikainen, Vihti (FI); Asta I. Bäck, Espoo (FI); Sari Eliisa Vainikainen, Ojakkala (FI); Raimo J. Launonen, Nummela (FI); Markku Kylänpää, Helsinki (FI); Caj Gustav Södergård, Espoo (FI); Aino J. Mensonen, Kauniainen (FI)

(21) Appl. No.: 15/515,507

(22) PCT Filed: Sep. 23, 2015
(86) PCT No.: PCT/US2015/051754

§ 371 Date: Mar. 29, 2017

Related U.S. Application Data
(60) Provisional application No. 62/057,513, filed on Sep. 30, 2014.
(60) Provisional application No. 62/127,169, filed on Mar. 2, 2015.

(51) Int. Cl. G06Q 30/02; G06F 17/30; H04L 29/06; G06Q 30/06

(52) U.S. Cl. CPC G06Q 30/0201; G06Q 30/0615; G06F 17/30082; H04L 63/14; H04L 63/1466; H04L 63/30

(57) ABSTRACT

Systems and methods for use in a secure personal data marketplace are disclosed. In accordance with one method, a request for processed user data from a requesting party is received at an electronic marketplace. The request for the processed user data is published from the electronic marketplace to a plurality of responding agents. The plurality of responding agents determine whether one or more of the users will be a user participant. The responding agents send the user information for the user participants to the electronic marketplace, where the user information is processed in a trusted environment to generate the processed user data requested by the requesting party. The processed user data is sent from the electronic marketplace to the requesting party, and the user information and processed user data is deleted from the electronic marketplace once the processed user data has been sent to the requesting party.

### CROSS-REFERENCE TO RELATED APPLICATIONS

The present application claims priority to Provisional Application Ser. No. 62/057,513, filed Sep. 30, 2014, titled “SECURE PERSONAL DATA MARKETPLACE”, and to Provisional Application Ser. No. 62/127,169, filed Mar. 2, 2015, titled “TRUSTED ACTIVE MAILBOX APPARATUS AND METHOD”, both of which are incorporated in their entirety by reference.

### BACKGROUND

The trading of personal data, such as consumer data, is a nascent industry. It is most common for personal data to be monetized in an indirect fashion. People use free services, and as they use these free services, they generate data about their interests and intentions. This data is then used by the service provider to provide, for example, targeted advertising to users. Users get a free service in return for sharing data on their preferences and activities, and the service provider gets revenue by selling advertising contacts. Free online services from providers such as Google, Yahoo, and Facebook operate in this manner.

In addition to these advertisement-driven services, there are data brokers that accumulate and analyze personal data and sell it to private persons and organizations at different levels and for different purposes. These services do not typically have any direct contact to people whose data they process. They collect data out of public records and perform various types of data collection, mainly in online environments.

There are increasing concerns about these models because, in general, people do not have knowledge of what data has been collected and stored or how that data is being used, potentially compromising user privacy. There is pressure from law makers to increase transparency and to give individuals more control over date pertaining to them data. Developing new kinds of solutions and services for managing personal data may be desirable.

Protection of private information is important in the context of consumer and citizen surveys. One approach for handling surveys is a centralized approach in which a data owner (e.g., a census bureau) collects all of the data regarding a particular user set and is the owner of the collected data. Anonymization is typically handled by the data owner which, as stated previously, has full access to all data properties. The data owner is responsible for calculating statistical values (e.g., average income) and publishing results in a way that preserves anonymity. Such a traditional approach is static and is limited to queries that the owner of the centralized data is willing to support.

A thorough anonymization process must take into account diversity of the data fields that are to be exposed. Simple methods, such as leaving out identity-related fields and replacing sensitive data fields with random identifiers can be vulnerable to re-identification attacks if it is possible for a malicious organization to link the anonymized data with publicly available data. One example of a data breach is a case in which anonymized health insurance data of approximately 135,000 family members of Massachusetts state employees was collected for research purposes. However, it was soon detected that it was possible to link the believed-anonymized data to real identities by using information from a publicly accessible voter registration list.

The case led to a more precise formulation of anonymity. An anonymization process is said to provide k-anonymity if the information regarding each user that is included in the data set cannot be distinguished from at least k-1 users whose information also appears in the data set. By using the k-anonymity principle, it is possible to check certain identifying attributes so that individuals are not easily re-identified by malicious organizations. For example, using k=10 k-anonymity, it is required that there exists at least ten possible identity alternatives in a given data set. In some examples, this could be achieved by replacing a birth date with a birth year or by combining ZIP code areas into larger regional zones.

However, even though a data set is k-anonymized, it still does not always provide true anonymity. Attacks against k-anonymized data sets are described in: A. Machanavajjhala, D. Kifer, J. Gehrke and M. Venkitasubramaniam, “L-diversity: Privacy beyond k-anonymity,” ACM Transactions on Knowledge Discovery from Data (TKDD), vol. 1, no. 1, 2007.

Such attacks are based on either a homogeneity of certain fields of the data set or a background knowledge that allows an attacker to re-identify persons in the anonymized data set. To help mitigate these threats, another concept called l-diversity is employed. Sensitive attributes should be diverse. For example, if there is a health database containing diagnosis information and identifying attributes have been k-anonymized, it does not help if all cases have the same diagnosis.

Even the l-diversity concept has its limitations and a more comprehensive anonymization metric called t-closeness has been engineered. A set of records with the same anonymized data is said to have t-closeness if the distance between the distribution of a sensitive attribute in this set and the distribution of the attribute in the whole table is no more than a threshold t apart. A table is said to have t-closeness if all sets of records with the same anonymized data have t-closeness. Still, there is never a guarantee that an anonymization process will protect against all re-identification attacks while preserving the usefulness of the data set for data mining purposes.

### SUMMARY

Systems and methods for use in a secure personal data marketplace are disclosed. In accordance with one method, a request for processed user data from a requesting party is received at an electronic marketplace. The request for the processed user data is published from the electronic marketplace to a plurality of responding agents, wherein each of the plurality of responding agents is in electronic communication with one or more users. The plurality of responding agents determine whether one or more of the users will be a user participant. The responding agents send the user information for the user participants to the electronic marketplace, where the user information is processed in a trusted environment to generate the processed user data requested by the requesting party. The processed user data is sent from the electronic marketplace to the requesting party, and the user information and processed user data is deleted from the electronic marketplace once the processed user data has been sent to the requesting party. Each of the plurality of responding agents may be associated with a respective one of the plurality of users.

In various examples, the trusted execution environment comprises a sandbox and/or an ad-hoc mailbox. The request for processed user data may include a request to execute computer instructions, wherein the processing of the user information includes running the executable computer instructions on the user information in the trusted execution environment. The executable computer instructions may be verified as trustworthy by the responding agents before sending the user information to the electronic marketplace. In one example, the executable computer instructions perform statistical analysis on the user data sent by the plurality of responding agents.

In other examples, the request for processed user data includes information identifying a minimum number of user participants required by the requesting party before the processed user data will be accepted by the requesting party. Further, the request for processed user data may include information identifying a maximum number of user participants to be used by the electronic marketplace to generate the processed user data. Still further, the request for processed user data may include information identifying compensation to be provided to each user participant in exchange for the user information. Still further, the request for processed user data includes an expiration time, where user data from the user participants is not accepted at the marketplace after the expiration time.

In other examples, the plurality of responding agents send user information from one or more user participants associated only if the request for processed data is above a corresponding user's anonymity threshold.

In accordance with another disclosed system and method, the method includes: receiving user data from a plurality of users, each user having a respective anonymity threshold; identifying a selected set of users from the plurality of users; generating processed data from the user data of the selected set of users; determining an anonymity level of the processed data; only if the anonymity level of the processed data is above the anonymity threshold of all of the users in the selected set, providing the processed data to a requesting entity. The anonymity level may be a metric selected from the group consisting of k-anonymity, l-diversity, and t-closeness. In one example, if the anonymity level of the processed data is not above the anonymity threshold of all of the selected users, a different selected set of users is identified.

A secure personal data marketplace system is also disclosed. The system may include: an electronic marketplace server; an organization server configured to send a request for processed user data from a requesting party to the electronic marketplace server; and a plurality of responding agent modules, each associated with a respective user device, wherein the electronic marketplace server is configured to publish the request for processed user data to the plurality of responding agent modules, wherein the plurality of responding agent modules is configured to transmit the user information to the electronic marketplace server. The marketplace server may be further configured to: 1) process the user information in a trusted environment at the electronic marketplace to generate the processed user data requested by the requesting party; 2) send the processed user data from the electronic marketplace to the requesting party; and 3) delete the user information and processed user data from the electronic marketplace once the processed user data has been sent to the requesting party.

In one example of the system, the plurality of responding agent modules transmits the user information to the electronic marketplace server based, at least in part, on an anonymity threshold. The anonymity level is a metric selected from the group consisting of k-anonymity, l-diversity, and t-closeness. Still further, the request for processed user data may include an upper and lower limit on the number of users that are to participate in the request.

### BRIEF DESCRIPTION OF THE DRAWINGS

FIG. 1 is a schematic block diagram illustration of one example of a system architecture that may be used to obtain data from a plurality of users to a requesting party using a trusted marketplace as the intermediary.

FIGS. 2A-B shows an example of a system architecture and corresponding data flow, where a marketplace acts as a trusted intermediary for the exchange of information relating to personal user data between a requesting party and a plurality of users owning the user data.

FIGS. 3A-B shows a further example of a system architecture and corresponding data flow, where a marketplace acts as a trusted intermediary for the exchange of information relating to personal user data between a requesting party and a plurality of users owning the user data.

FIG. 4 shows an example of a system architecture and corresponding data flow, where the requesting party is the user.

FIG. 5 shows an example of a system architecture and corresponding data flow, where the requesting party is a user seeking to purchase an app from an offering party.

FIG. 6 shows another example of a system architecture and corresponding data exchange flow that may be used to implement a secure transfer of information relating to user data between an organization and a user, where the user data is stored on a device that is under the control of the user.

FIG. 7 shows one example of a system architecture using a trusted active mailbox.

FIG. 8 shows one example of a system and corresponding data exchange flow that may take place when a trusted mailbox is used at the marketplace to execute, for example, statistical operations on the user data.

FIG. 9 shows one example protocol that may be used for requesting attestation of the trusted active mailbox.

FIG. 10 shows one example of a communications system in which one or more of the system architectures may be implemented.

FIG. 11 is a diagram of one example of a WTRU.

FIG. 12 is a diagram of one example of a network entity.

### DETAILED DESCRIPTION

Personal data is very sensitive. If personal data of many people is gathered at one central storage point, it becomes a target for data breaches and thus presents a risk both for users and for the service provider.

A market for personal data differs from stock markets because the nature of the objects of sale is much more varied. In stock markets, the object of the sale is clear: sellers offer a price at which they are prepared to sell a stock, buyers offer a price at which they are prepared to buy, and the bids can then be matched. Personal data is much more complicated to exchange. The amount and sensitivity of the user data may vary significantly from request to request. It is difficult for the user to determine the compensation that is to be paid to the user for the user data. It may also be difficult for the user to determine whether the request for and/or use of the information is secure and/or trustworthy. The present disclosure thus provides a system that can evaluate the adequacy of the offered compensation as well as information relating to the security and/or trustworthiness of the request.

In some embodiments, a personal data marketplace operates on metadata, and the personal data is not permanently stored at the marketplace. Requests can be described in terms of metadata, and this metadata used to advertise the request. First, it is desirable to find the parties whose data is of interest, and then to find those who have the requested data and are willing to sell or share it.

The marketplace may include the functionality to connect data-requesting and data-offering parties via a temporary connection point. This allows the identity of the data seller to be hidden from the data buyer. Each user's personal data stays at the user-controlled trusted environment (e.g., user computer, user mobile device, user server, etc.) and if the user wants to share data, the data is channeled to the receiving party without using central data storage. For example, the data can be stored in a central storage for the requesting party to fetch, so that no direct connection is needed between the user and the requester. The only exception to this is that data can be temporarily stored at a marketplace-controlled trusted execution environment (e.g., a “sandbox”), such as a secure server, virtual machine, or other trusted execution environment. The data is processed at the trusted execution environment before being sent to a receiving party. The receiving party may be the requesting party itself or an entity authorized to receive the processed data by the receiving party. For purposes of the following discussion, it is assumed that the receiving party is the requesting party.

A marketplace-controlled trusted execution environment can be implemented in many ways, such as utilizing a hardware-based trusted execution environment, using pure software-based techniques, or a combination of both. In addition to security, flexibility and compatibility with existing operating systems should be taken into account when selecting a method for implementing the marketplace-controlled trusted execution environment.

Data to be sent for processing in the market-controlled trusted execution environment contains only what is requested in the request for processed user data received from the requesting party as opposed to all of a user's data. Once the result has been processed and the result delivered to the requesting party, all the data will be deleted from the Marketplace. If a new, similar request for processed user data is sent to the Marketplace, the data would to be fetched again from the users as opposed to being processed from any existing user data at the Marketplace.

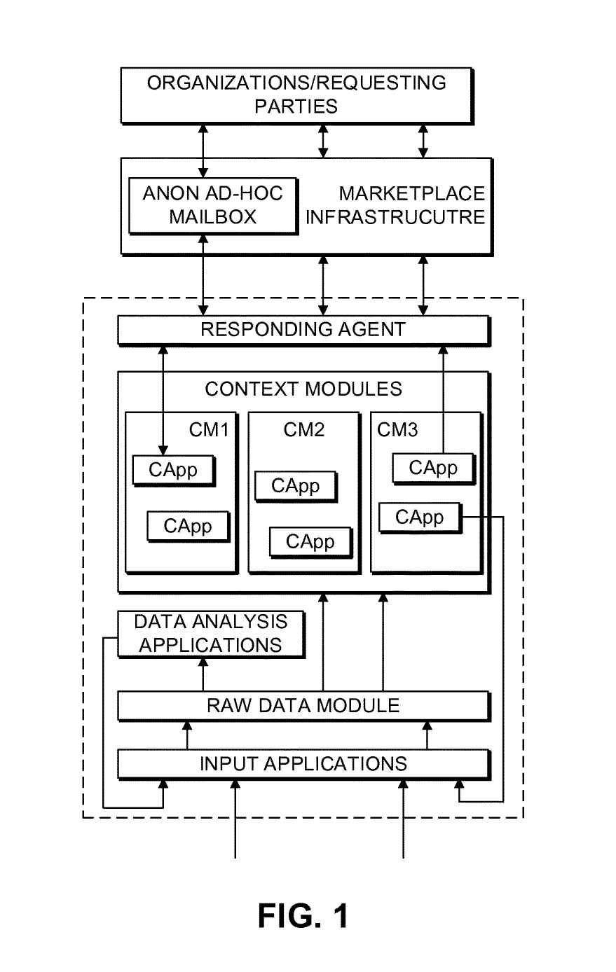

In the example shown in FIG. 1, data extraction from the user's personal data storage takes place with the help of Context Modules, which may encapsulate domain-specific personal data. Personal data is available to certain applications, referred to herein as Context Applications (“CApps”), and to organizations through Context Modules. Each Context Module contains data that data-mining CApps can use in data mining. A Context Module may contain data relevant to a specific context or topic (e.g. travel, house). The data may originate from automatic and/or manual sources, and is filtered out of a Raw Data Module to contain only data that relates to each specific context or topic. Examples of general Context Modules are Real Time Context, Finance, Travelling, Home, Fitness, Entertainment, Transportation, Food, Shopping, Ownerships, Hobbies, Work; some Context Modules may even be dedicated to highly sensitive data, such as Health Records or Online Gambling data. There can be also more focused (narrower) Context Modules. For example there could be a subset of Entertainment for movies, or subset of Shopping for clothes-related data. There may also be information which defines portions of user data, such as basic descriptive data, such as Contact Data, Household members, Demographics, Relationships. This information can be used to provide a connection to different Context Modules and CApps. Context Modules may combine different types of data. New Context Modules can be created based on demand.

In some examples, a CApp is closely related to the context of a Context Module. In other examples, generic CApps can be provided to allow visualization of the personal data of a user and to enable a user to modify and update his or her personal data. In some examples, a CApp offers a service that combines different functionalities within a single CApp. Specific CApps can be used for data mining in Context Modules. CApps can also indirectly communicate with the Marketplace. Such communications may be conducted through a Responding Agent that checks to ensure an appropriate level of user anonymity. In some embodiments, CApps have a user interface. In other embodiments, a CApp can be used that does not have any user interface.

To maintain users' trust in the system, it may be communicated to the users that the data in a Context Module will be accessible to CApps and data requests from the Marketplace. Further, if applicable, the user may be advised that the data may be sent to external parties. This communication may be made even though there are additional steps a user can take to accept or reject a CApp requests and/or data requests.

The amount of data to be sent to the receiving party can vary from one piece of data to an extensive data set. Through the use of CApps, private user data need not leave the user's system, shown here in dotted outline. Specifically, the user data does not leave the components enclosed in dotted outlines except when user-specified rules are followed and the anonymity threshold is guaranteed to the user's satisfaction.

The Requesting Party may send a request for processed user data to the marketplace. The request may include an offer of compensation to the user for the user data. The compensation may be a monetary compensation or some other benefit, such as redeemable discount codes. Because the Marketplace offers the parties represented by Responding Agents the opportunity to stay anonymous towards Requesting Parties, the Marketplace operates to manage and channel the compensation. The Marketplace can use an internal unit for compensation, and the data-selling parties could then decide in which way they utilize the compensations. For example, the compensation could be exchanged for cash, to discount coupons, or other items of value to the user.

In order to make participation in the Marketplace easier for the user, the decisions of whether the user data should be shared or sold can be automated, at least in part, using the Responding Agent to act on the user's behalf. In various examples, each Responding Agent may be associated with a respective user/user device. The user can give initial values and rules that the Responding Agent uses for making decisions on the data sharing. For example, the Responding Agent may determine the adequacy of the compensation offered by the Requesting Party. Additionally, or in the alternative, the Responding Agent may determine whether the data request and/or operations to be executed on the data at the Marketplace meet the threshold security requirements set by the user. If the decision is not clear (either yes or no), the Responding Agent may ask the user to clarify the compensation and/or security requirements. The user's response may be used by the Responding Agent to update rules for making future decisions.

The Requesting Party may use minimum and maximum values for user participants from whom the user data is to be collected. The minimum defines the minimum number of replies (e.g., user participants) desired to get enough data to be able to do meaningful analysis. The maximum value sets a limit on the total amount of compensation that needs to be paid user participants. There may also be an expiration time for the request. If there are not enough replies by the time the request expires, the requesting party may try again with the same request but with a higher offer of compensation. The Responding Agents may also inform the data-requesting party of other requirements, such as a portion of the requested data that the user is willing to make available for the offered compensation. That is, the Responding Agents may prepare a counter-offer to specify an alternative amount of data and/or an alternative level of compensation.

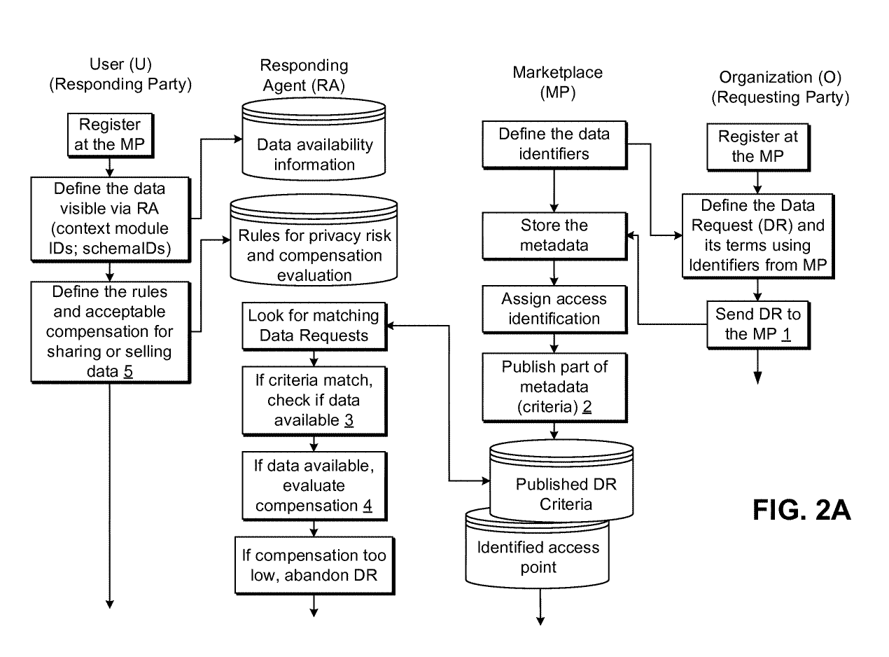

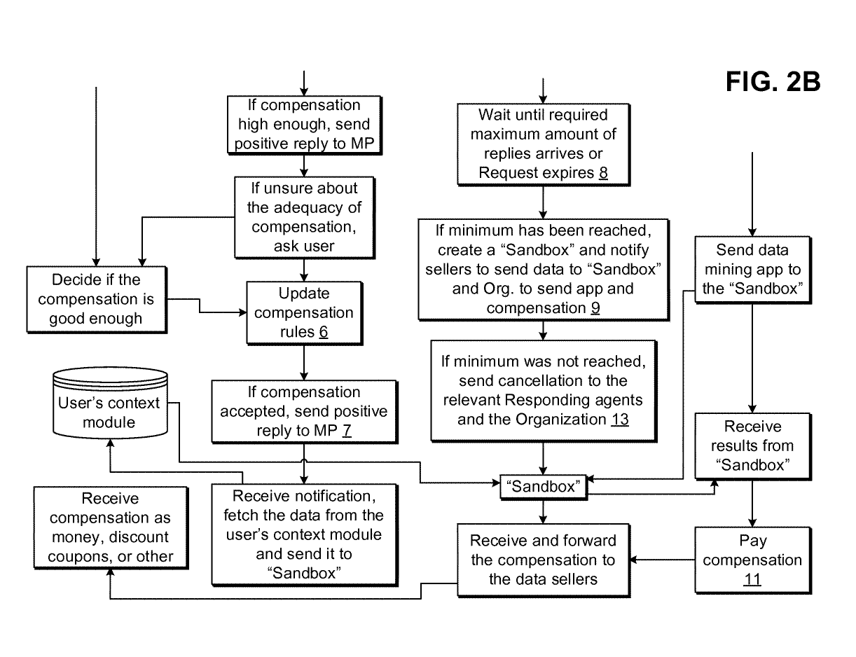

FIG. 2 shows a system architecture and corresponding data flow, where the Marketplace acts as a trusted intermediary for the exchange of personal user data between a Requesting Party, such as an organization, and a plurality of users owning the user data. Here, the organization, as the Requesting Party, places a request to the Marketplace requesting some processed user information derived from specified user data. The Requesting Party may define a specified number or range (e.g. 100 to 200) of user participants and may offer a compensation for providing the data to them. The request may specify that the individuals have certain specified characteristics (e.g. belong to a certain age group, or living in a named area, or owning a certain device) before participating in the request. The requested information is not sent directly from users to the Requesting Party. Instead, the data is processed in between the users and the Requesting Party at the Marketplace. As a result, the user data is not directly available from the user. Rather, the Marketplace provides processed user data, may include data that is calculated (or mined) out of the datasets that the individual users provide.

A Requesting Party is one of the registered members of the Marketplace. In registration, the members advantageously get a public key—private key pair, which can be used for signing portions of data or encrypting any data which is targeted for a limited number of recipients. In one method, the Requesting Party sends a Data Request (Data Notification) to the Marketplace. The Requesting Party (e.g., organization) wants to have data that individual users, each of them represented by a Responding Agent, can provide. The Data Request may specify the identifier of the Context Module (user activity) that contains the required data, and the identifiers of the requested data items as defined by the Marketplace. The Data Request specifies that the Requesting Party wants to do data mining on the dataset using a trusted execution environment that the Marketplace offers. The Requesting Party also sends to the Marketplace an application to be executed within the trusted execution environment to perform analysis (such as data mining) on the user data. Only the results that the application produces will be available to the Requesting Party. The individual user datasets are not made available to the Requesting Party.

In some systems, the Data Request also specifies information identifying the types of the users whose data is of interest. The Requesting Party also specifies a compensation it will pay to the users who provide the requested data, as well as the minimum and maximum numbers of replies it requires. Too small a number of replies may not be useful to the Requesting Party; the maximum limits the costs of the number of replies it needs, which means that the Requesting Party will not pay compensation for any repliers that exceed the set maximum. There will also be an expiration time for the request.

In FIG. 2A-B, a Requesting Party (e.g., organization) sends the Data Request with the above-described definitions to the Marketplace (1). The Marketplace receives the Data Request, stores its metadata, and links it with access identification, which may be a temporary ad-hoc mailbox. The Marketplace publishes (2) the criteria that the repliers need to meet. The Responding Agents have access to this information, and they may check whether the user they represent meets the set criteria.

Once the Responding Agent finds a Data Request the criteria of which its user meets, the Responding Agent checks (3) if the user can provide the requested data. If so, the Responding Agent will perform a comparison of the compensation that the Requesting Party is ready to pay and the level of compensation that the user expects (4). Here, user-defined rules and compensation levels are utilized to make the compensation. The user may have defined the rules and compensation level, when she started to participate in the said Marketplace (5). The rules may be also defined and modified later on.

If the compensation is too low, the Responding Agent stops processing the Data Request. If the compensation is high enough, the Responding Agent proceeds with sending a positive reply to an Identified Access Point without notifying the user. In some instances, the Responding Agent may determine that the compensation is at a borderline level, neither too low to be clearly rejected nor too high to be clearly accepted. In such borderline cases, the Responding Agent asks the user whether a reply should be sent. The rules for evaluating where the acceptable level of the compensation is may be updated based on this reply (6).

Once the level of compensation has been approved (either directly by the Responding Agent or after the user has confirmed the adequacy of the compensation), the Responding Agent sends a positive reply to the Identified Access Point at the Marketplace (7) and confirms that it can provide the requested reply fulfilling all the mandatory criteria. The Marketplace waits until it has received the maximum requested number of replies, or until the Data Request Expiry date is reached (8). If the Requested minimum number of replies has been reached, the Marketplace creates or activates a trusted execution environment for processing of the data and notifies the Responding Agents to send the data (9) to the trusted execution environment. Each Responding Agent fetches (10) the requested data from respective user's Context Module, and delivers it to the trusted execution environment for data mining. The Marketplace notifies the Requesting Party to pay the agreed-upon compensation (11) and to send the data mining application to mine the received data in the trusted execution environment (12).

If there are not enough replies, the Marketplace notifies the Requesting Party and those Responding Agents that had sent a positive reply that the Request expired and the Responding Agents can cancel the Data Request. Users will not be paid any compensation. The Requesting Party may place a new Data Request for the same data with the Marketplace but offer a higher compensation in order to encourage more people to share the data.

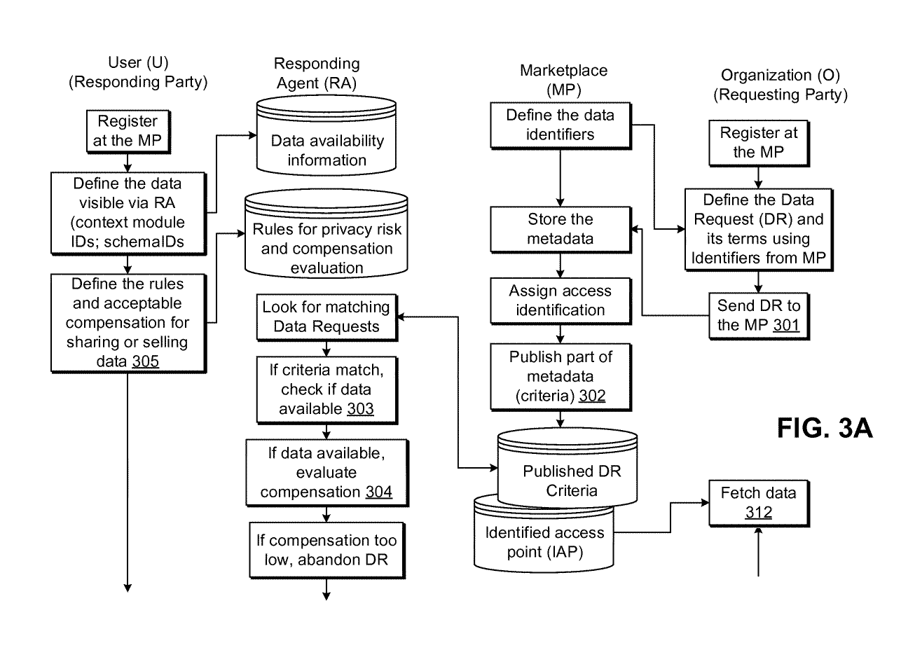

Another personal data exchange system is described with respect to the system architecture and corresponding data exchange flow shown in FIG. 3. A Requesting Party may request some processed user data from the Marketplace, where the processed user data corresponds to specified data from a set of users within a specified range of sizes, e.g. 100 to 200 individual users, the Requesting Party may offers a monetary compensation for the users to provide the data. A request from the Requesting Party may require responding individuals to have certain specified characteristics (e.g. they must belong to a certain age group, or live in a named area, or own a certain device). The data can be sent directly to the requester as individual datasets (e.g. there is not identifying data included or users accept that their identity may be revealed) as no data processing needs to be done either on individual or aggregated data. However, no data will be transferred if the minimum number of replies is not reached.

In the example shown in FIG. 3A-B, the Requesting Party is one of the registered members of the Marketplace and sends a Data Request to the Marketplace. The Requesting Party, as the Requesting Party, wants to have data that individual users (each of them represented by a Responding Agent) can provide. The Data Request may be used to specify the identifier of the Context Module (user activity) that contains the required data and the identifiers of the requested data items as defined by the Marketplace. The Data Request may also specify that individual datasets need to be delivered but that those datasets should be anonymized so that the Requesting Party need not treat the datasets as having personally-identifiable information (PII). The Data Request may also specify what requirements are set on the users who should provide the data. The Requesting Party may specify a compensation it will pay to the users who provide the requested data, as well as the minimum and maximum numbers of replies it requires. Too few replies may not useful to the Requesting Party, while the maximum limits the costs to the Requesting Party. There is also an expiration time for the request.

The Requesting Party sends a Data Request with the information described above to the Marketplace (301), which receives the Data Request, stores the metadata of the Data Request and links the Data Request with access identification, which may be a temporary mailbox. The Marketplace publishes (302) the criteria that the repliers need to meet so that Responding Agents have access to the criteria and may check whether they meet the criteria.

Once the Responding Agent finds a Data Request having criteria which its user meets, it checks (303), if the user can provide the requested data. If so, the Responding Agent performs a comparison of the compensation that the Requesting Party is ready to pay and the level of compensation that the user expects (304). Here, user-defined rules and compensation levels are utilized to make the compensation. The rules setting required compensation levels may be defined when the user starts to participate in the Marketplace (305).

If the compensation is too low, the Responding Agent stops processing the Data Request. If the compensation is high enough, the Responding Agent proceeds with replying to the Data Request without notifying the user. If the compensation is in between these two cases, the Responding Agent sends an inquiry to the corresponding user seeking input as to whether to accept the compensation. The Responding Agent determines whether to reply to the Data Request based on the response from the user. In some embodiments, the Responding Agent updates the rules for evaluating the acceptable level of the compensation is based on the user's reply (306).

In the example of FIG. 3, when the compensation is accepted (either directly by the Responding Agent or after the user has confirmed the adequacy of the compensation), the Responding Agent sends a positive reply to an Identified Access Point at the Marketplace and confirms that the Responding Agent can provide the requested reply fulfilling all the mandatory criteria (307). The Marketplace waits (308) until it has received at least the minimum requested number of replies and then notifies (309) the Responding Agents that they can now send the requested data to the Identified Access Point (310), from where the requesting party fetches the answers (312). The Marketplace also notifies the Requesting Party to pay the compensation. The compensation (311) will be made available to the users providing the data via the Responding Agent once the replies have been made available to the Requesting Party. The user may define rules indicating whether data (including personally-identifiable information) can be sold under the appropriate circumstances, or whether personally-identifiable information must always be removed. In some embodiments, the Marketplace may process the user data by removing individually-identifiable information before the data is sent to the Requesting Party.

The request remains available until the specified maximum number of requests has been received or the request expires (313). If there are not enough replies, then no replies are delivered to the Requesting Party, and no user will get compensation. A cancellation will be sent to the Responding Agents that had indicated that they could deliver the answer.

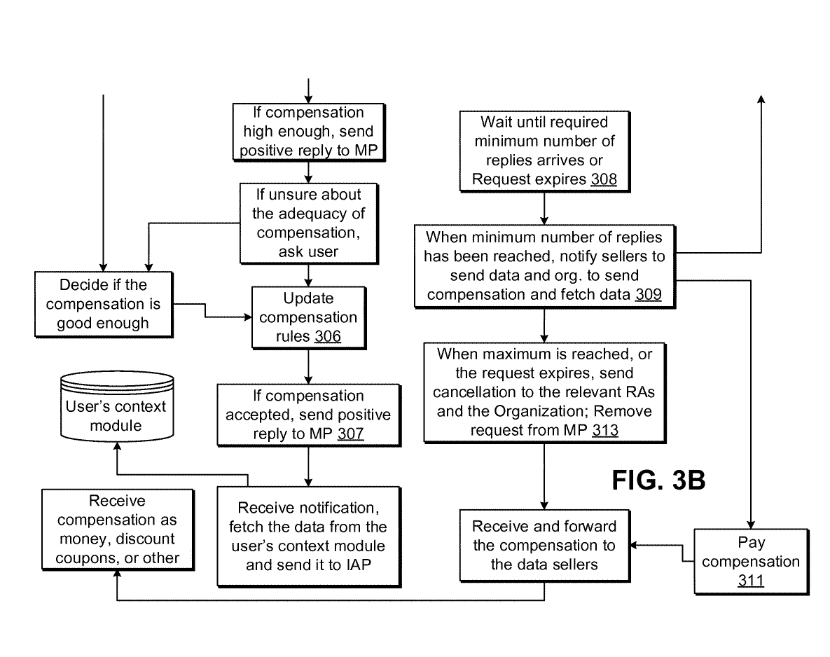

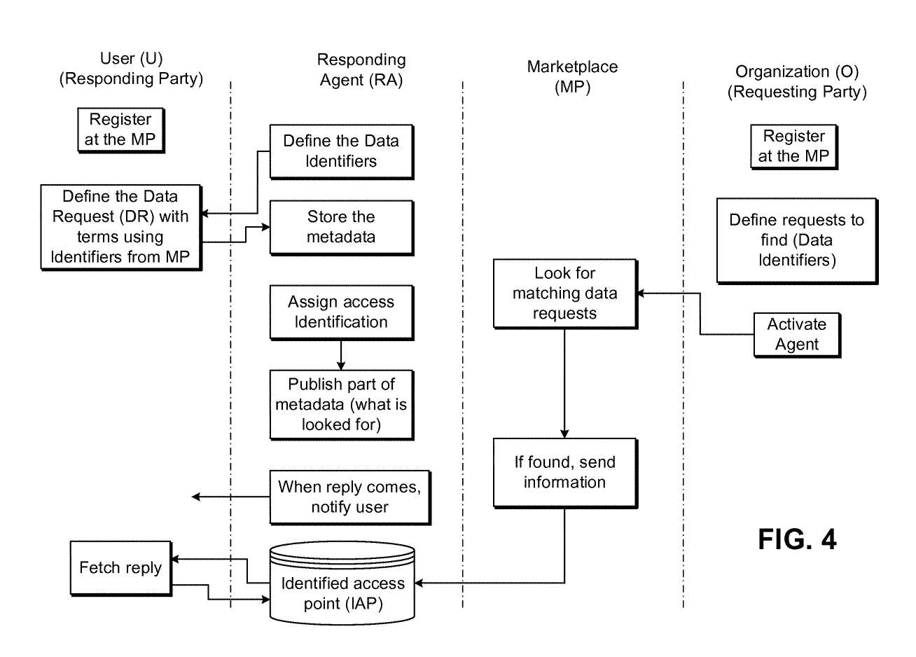

Another embodiment of the system is described with respect to FIG. 4. In this example, an individual user is the Requesting Party and requests data relating to her intention to buy a product or service. The request by the user is placed to the Marketplace. The data she expects is typically advertisements and offers for this product.

In FIG. 4, the Requesting Party is one of the registered members of the Marketplace and sends the Data Request to the Marketplace. The Requesting Party (i.e., user) is looking for data from Offering Parties (e.g., organizations) that can offer products that she is intending to buy. The Data Request specifies the product category (e.g. televisions) that the user is interested in by using the identifiers defined by the Marketplace. The Data Request may also specify additional criteria for the product such as the price range and/or the time range when the user is planning to make the purchase. The Data Request could also be used to identify one or several specific products if the user knows exactly what she wants. The request may also include some profile information if the user assumes that sharing the profile will bring her better offers. The profile information may contain such portions of user data which describes the user in generic terms or include information of habits or other behavior that may help in fulfilling the need.

The user, as the Requesting Party, sends the Data Request with the above mentioned metadata to the Marketplace. The Marketplace receives the Data Request, stores the metadata, and associates the Data Request with access identification, which may be a temporary mailbox. This way the identity of the user participant remains hidden from the organization. The Marketplace publishes the metadata so that Responding Agents of Offering Parties have access to it. Offering Parties are looking for customers who are interested in products that they sell.

Once a Responding Agent finds a Data Request that relates to the products of the organization, it sends a reply via the Marketplace using the access identification given in connection to the Data Request. The Marketplace computes a message to the Requesting Party when at least one message is received from a Responding Agent.

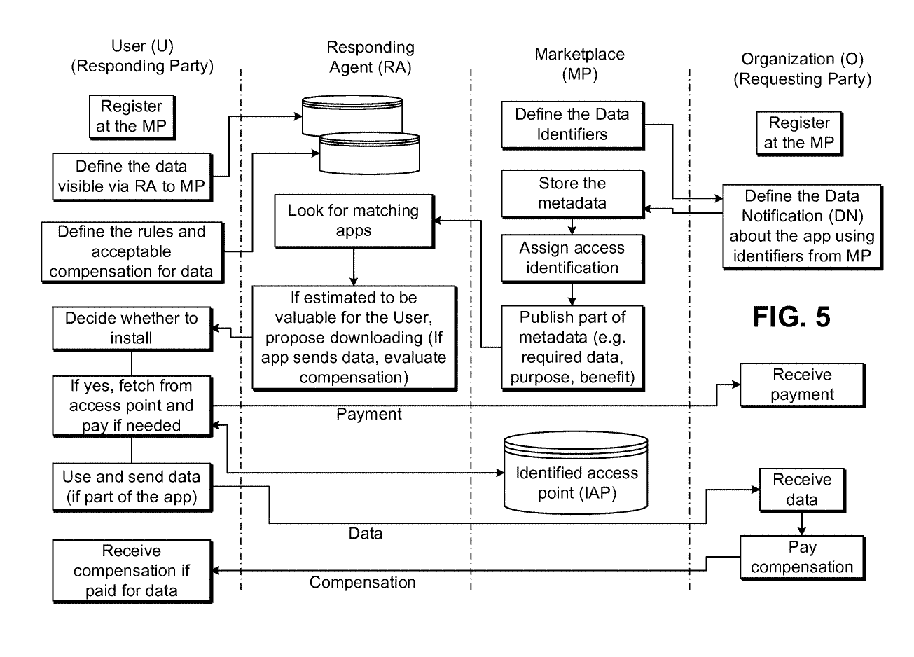

A further example of the use of the Marketplace as a trusted intermediary between a user and a Requesting Party is illustrated with reference to the system architecture and corresponding data exchange flow shown in FIG. 5. Here, an Offering Party (i.e., organization) offers an application (computer executable code, CApp) that is capable of processing personal data that the user has gathered and made available to other parties. The application provides some benefit to the user, such as saving time, making better decisions, or earning money.

The Offering Party is one of the registered members of the Marketplace and sends a Data Request for an application (computer executable code) to the Marketplace. The Data Notification includes the downloadable computer executable code and metadata describing the application, such as a description of what benefits the code offers, what data it requires (the identifier of the required Context Module) what data the application exports, if any, and, if the application exports data, how the user will be compensated for the data. Advantageously, the application and its metadata may be signed by the organization.

The organization sends the Data Notification with the above described definitions to the Marketplace, which receives the Data Notification, stores the metadata and creates access identification for the Data Notification. The Marketplace publishes the metadata so that Responding Agents can find it. Responding Agents actively look for applications that utilize the Context Modules that their respective user has installed and where she has data available for applications. By installing a Context Module, the user indicates that she is interested in CApps that utilize her data that is available via the said Context Module.

Once the Responding Agent finds a Data Notification of a CApp that it assumes to be of interest to the user, it suggests that the user install the CApp. If the CApp exports data from the user to the Requesting Party, the Responding Agent determines whether the compensation is sufficient in the manner described above. When the user downloads the application, the Marketplace computes a message and sends it to the Requesting Party to report the download. The identity of the downloading user is hidden from the Requesting Party.

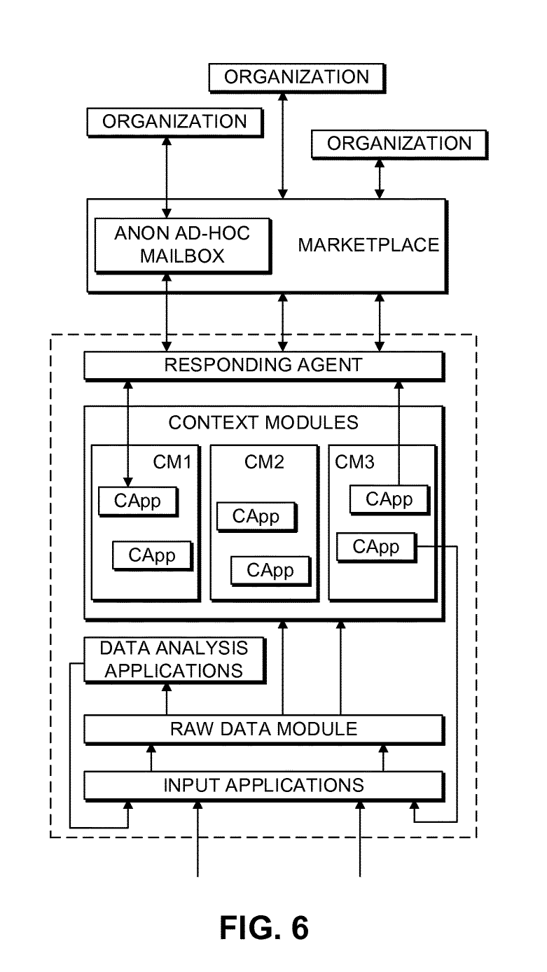

FIG. 6 shows another example of a system architecture and corresponding data exchange flow that may be used to implement a secure transfer of information relating to user data between a Requesting Party and a user, where the user data is stored on a device that is under the control of the user. In particular, FIG. 6 depicts a set of organizations in communication with the Marketplace. In turn, the Marketplace is in communication with wireless transmit receive units (WTRU) of a plurality of users. A single WTRU is depicted here within the dotted outline.

The Marketplace may include a set of anonymous ad-hoc mailboxes. The Marketplace and the included anonymous ad-hoc mailboxes are in communication with the Responding Agent, shown here as residing on the WTRU of the user. The system architecture further includes a set of context modules (CM1, CM2, CM3), each context module including a respective set of context applications (CApps). Context modules may be virtual machines or other mechanisms used to provide data security and integrity, for example by allowing only limited intercommunication between applications in different context modules.

The Marketplace can receive data from various context module applications. Additionally, the Responding Agent may communicate with the various context module applications. The system architecture further includes respective sets of data analysis applications, raw data modules, and input applications. The set of input applications can receive data from the set of data analysis applications, the set of context applications, as well as various other sources (e.g., public and private compiled data sets, census data, etc.). The raw data module receives data from the set of input applications. The raw data module outputs data to the set of data analysis applications as well as to the set of context modules. Each context application can make use of data sent as input to its corresponding context module.

In one example, individuals receive requests from Requesting Parties for personal data. Individuals have the option to monetize access to their personal data in a way they deem suitable. Each user's Responding Agent may act on behalf of the user and send the user's personal data to a Requesting Party using the Marketplace as a trusted intermediary. The user, through the Responding Agent, may require some form or guarantee of compensation from the Requesting Party before granting the Requesting Party access to the user's personal data. At least one mechanism that is supported by the architecture depicted in FIG. 6 is the sending of targeted recommendations and advertisements from organizations to individuals. In an exemplary embodiment, users do not receive targeted recommendations or advertisements unless they request them.

The system architecture depicted in FIG. 6 may also be used for various statistical purposes. For example, an organization in the set of organizations might want to calculate an average value of a numerical property from individuals who satisfy a certain criterion. As a specific example, the Requesting Party might want to check an average income of a certain population group living in a certain geographical area using a certain sample size, e.g. N=200. The Requesting Party may write a query (using, e.g., SQL or other query language) to mine the necessary data. A query reply contains information that may be generalized. For example, specific age values may be generalized to an age range, such as 20-30 or 30-40.

In some instances, a user's personal Responding Agent may enforce one or more rules that restrict providing exact information, such as exact “income—age” information to the Requesting Party, as the inclusion of exact age and exact income can be used by a malicious organization to identify the user as a member of a group matching to the criteria. Because the malicious organization has access to public records (e.g., census data, tax information, etc.), this information can be used to identify the individual. If the match criterion is something that an individual does not want to be publicly known, there exists an anonymization and privacy problem.

In some examples, an individual associated with a Responding Agent can communicate with the Requesting Party via an anonymous ad-hoc mailbox. In some embodiments, an anonymous ad-hoc mailbox resides in the Marketplace. Individuals represented by a Responding Agent, as well as Requesting Parties seeking data, have a certified public/private RSA key pair. An organization running a campaign publishes the campaign in the Marketplace. A user's Responding Agent compares the published information regarding the campaign with predetermined criteria set by the user to determine whether the user is willing to participate in the campaign. The Responding Agent further determines whether the user matches the published criteria for the campaign sends a signed and encrypted reply to an anonymous ad-hoc mailbox. However, as a result of this signed and encrypted reply, the Requesting Party may get too detailed information about individuals replying to the campaign e.g., exact “income—age” information. Consequently, embodiments disclosed herein may employ an active trusted element that is able to perform statistical calculations (e.g. average value) on data received at an anonymous ad-hoc mailbox. Such an active element is preferably located in a user-organization neutral zone. An anonymous ad-hoc mailbox provides communication services for network nodes having intermittent network access. It is a static data transfer service that can be protected by encryption.

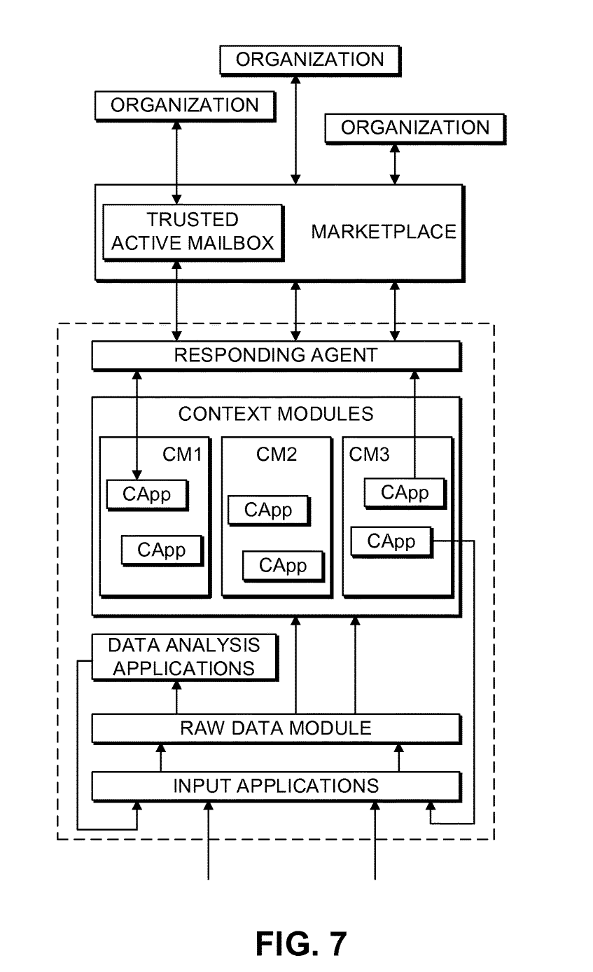

FIG. 7 depicts an extension of the system architecture shown in FIG. 6. Here, The Marketplace contains at least one trusted active mailbox which can host anonymous ad-hoc mailboxes and can also execute code for performing statistical calculations on data received via the hosted anonymous ad-hoc mailboxes. A result of the statistical calculation is sent to the Requesting Party. The user data which is sent to the trusted active mailbox is not sent to the Requesting Party. Rather, a trusted active mailbox is implemented as an anonymous ad-hoc mailbox running in a trusted data mining sandbox (TDMS).

In the example shown in FIG. 7, the trusted data mining sandbox (TDMS) includes an anonymous ad-hoc mailbox. The TDMS may be used as a trusted execution environment in which a system can securely process data calculations. By adding a TDMS element to the Marketplace and including, within the TDMS, the anonymous ad-hoc mailbox, the system of FIG. 7 can securely process data calculations. The trusted active mailbox, which provides processing and data gathering services to message data, can be implemented as an expansion of the system architecture of FIG. 6. The trusted active mailbox may be shut down after the processed user data is obtained by the Requesting Party. The trusted active mailbox may be shut down as a result of a command sent from the Requesting Party or even the Marketplace itself (for example, due to a session timeout or a lack of willing participants).

It should be noted that the term “mailbox” as used herein refers to the provision of communication services and does not necessarily require the use of any particular communication protocol, such as the simple mail transfer protocol (SMTP). Other communication protocols, such as the hypertext transfer protocol (HTTP) may be used to communicate with the trusted active mailbox. However, the trusted active mailbox preferably provides for asynchronous communications, e.g. for communications with WTRUs that may have only intermittent network connectivity.

The trusted active mailbox may include the following functionality:
A TDMS instance may be reserved and used as a trusted active mailbox. The TDMS may be abstracted or virtualized in order to support multiple concurrent TDMS instances running within a single physical trusted execution environment.
An ephemeral RSA key pair may be created and a certification from the Requesting Party is requested. The Requesting Party certifies the key, and a certificate chain of the Requesting Party can be used to verify the authenticity of the trusted active mailbox.
The Requesting Party loads processing code and parameter data into the trusted active mailbox.

The trusted active mailbox operates in a manner similar to a passive anonymous ad-hoc mailbox specified in FIG. 6 by receiving data sent to the mailbox. However, the processing code and parameter data included in the trusted active mailbox contains instructions as to how much data should be collected and what operations should be performed on the collected data. Termination of the processing code logic may trigger a reporting phase.

In the reporting phase, specified calculations (e.g. average value) are reported to the Requesting Party. After the reporting phase, the trusted active mailbox is destroyed and the virtualized TDMS instance is freed.

In one specific example, the code running in the trusted active mailbox decrypts replies received from one or more Responding Agents representing associated users. When enough responses (e.g., N=200) are received, the trusted active mailbox stops accepting new replies, and then calculates an average income for each age range (e.g., 10-20, 20-30, 30-40). This age-income information is then available for the Requesting Party. As a result, the Requesting Party only has access to data that does not include any particular user's age-income information.

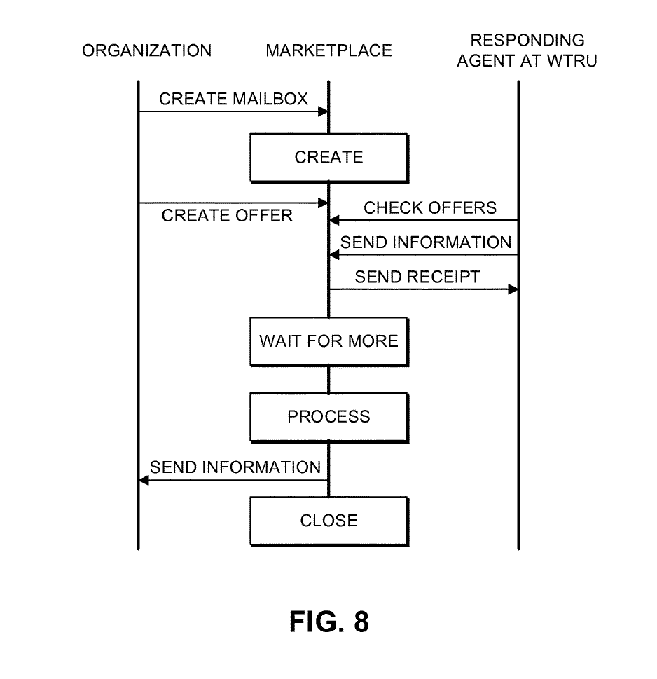

FIG. 8 shows one example of a system and corresponding data exchange flow that may take place between the Requesting Party, Marketplace, and Responding Agent when a trusted mailbox is used at the Marketplace to execute, for example, statistical operations on the user data. As shown, the Requesting Party places a request to the Marketplace to create the mailbox. The Responding Agent of participant users send their data to the mailbox. The user data is processed at the Marketplace in trusted environment and the processed user information is sent to the Requesting Party. Once the information has been sent, the mailbox is closed.

In this example, the trusted active mailbox and the Responding Agents engage in a process for conducting statistical calculations on survey results. Here, the Requesting Party communicates with the Marketplace by sending a trusted active mailbox creation request to the Marketplace. The creation request contains a high level description of the operation that is to be performed by the trusted active mailbox. The description includes input-fields requested and a formula to be used to generate the output data after a specified number of replies to the mailbox has been received. The Marketplace certifies an ephemeral RSA key that is created for the trusted active mailbox so that the trusted active mailbox can be verified by checking a certificate chain.

The Requesting Party then communicates with the Marketplace by sending a broadcast message to a Marketplace bulletin board specifying the address of the trusted active mailbox, a description of the operation to be performed in the trusted active mailbox, a criteria to be included to this survey, and an optional compensation offer.

The Responding Agent may check the bulletin board of the Marketplace and detects the survey request. The Responding Agent may then evaluate the match criteria and determine whether an individual associated with the Responding Agent is a part of the target group for this survey. Upon a determination that the user associated with the Responding Agent is part of the target group, the Responding Agent may evaluate the compensation offer and sensitivity settings of the requested information. When sensitive information is requested, the Responding Agent may also evaluate the operation to be performed in the trusted active mailbox and decide whether it is safe to participate in the survey.

If the Responding Agent determines that the user data may be used in the survey, the Responding Agent communicates with the trusted active mailbox by sending the requested information, which is encrypted using the public key of the trusted active mailbox, to the trusted active mailbox. The Responding Agent also sends its own public key to the trusted active mailbox. The trusted active mailbox may send a signed receipt indicating the user's participation in the survey so that the Responding Agent can request the promised compensation.

In another step, the trusted active mailbox increments a number of survey participants by one and checks whether the desired number of participants is reached. If the desired number of survey participants has not been reached, then the trusted active mailbox continues waiting for the next participant. If the desired number of survey participants has been reached, the trusted active mailbox ceases accepting participants into the survey and the requested average value information is calculated.

The trusted active mailbox communicates with the Requesting Party by providing the calculated information derived from the user data to the Requesting Party. The trusted active mailbox may then be shut down.

Additional intermediate steps may be performed in some examples. For example, the Responding Agent could verify that the trusted active mailbox calculation description matches the one published in the bulletin board. To this end, it may be desirable to ensure that the Responding Agent is able to trust that the program running in the trusted active mailbox is doing what it claims to do (e.g., calculate an average value of input data received). In some examples, the program code that runs in the trusted active mailbox is loaded from a repository that contains certified programs. In such instances, the source code of these programs may be available to the Responding Agent for recompilation so as to verify a binary executable. There may be signed assertions of program functionality, and parameter data may be provided in a format that can be automatically analyzed. In the system architecture of FIG. 8, the Responding Agent is able to decide whether it is safe to provide data of the associated user.

An assertion language may be used to define formula statements used to calculate statistical information from the user data. Additionally, or in the alternative, it may be a complex formula language such as the XBRL Formula language. A simple formula language may specify the formula using keywords for statistical functions (e.g., “AVG=average”) and reference data using variables. An example formula language program may look like the following:

AVG(x[0]..x[N])
//Parameters could be declared like
INT ARRAY x
//Parameter data assertion may map the symbol x to a schema field like
PARAMETER x = schema.org::Person.income
//References could use the syntax
<schema repository>::<schema name>.<field name>

A list of supported and known operations may be used. The trusted active mailbox may often be used to calculate average values and other statistical information on the user data. Example operations include average, median, standard deviation, mode, weighted average, and the like.

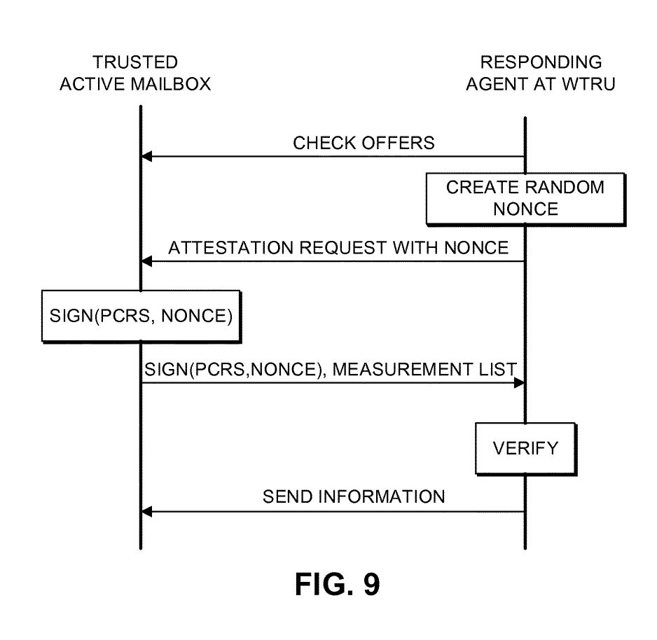

FIG. 9 depicts an example protocol that may be used for requesting attestation of the trusted active mailbox. In this regard, the Responding Agent can request attestation of the trusted active mailbox before sending the requested information.

Simply having a signed attestation of a statistical operation to be performed may not be enough to ensure a program is trusted. The Responding Agent may also use a remote attestation to request measurements from the TDMS and then verify that the software loaded into the TDMS matches a cryptographic hash of the expected statistical calculation software.

In at least one example, the trusted active mailbox instance is created, a new virtual machine instance is instantiated. The virtual machine instance will measure all of the executable code that is loaded onto the virtual machine. Measurement values are stored in a way that is protected by security hardware. Some virtualization of security hardware may also be employed. A potential example of such a system is a vTPM system which virtualizes a trusted platform module (TPM).

The virtual machine may utilize a set of integrity protected registers called platform configuration registers (PCRs), which can only be updated using an operation called extend. The extend operation for a particular PCR, PCRN may be defined as:

Extend(PCRN, value)=SHA1(PCRN∥value)

The old value of the register PCRN is concatenated with the value and a SHA1 cryptographic hash is calculated from the concatenated data. This cryptographic hash is then stored in PCRN. The value that is used in the extend operation should represent a measurement of a loaded executable or an element of critical configuration data. The virtual machine is configured in such a way that system a BIOS, boot loader, and operating system each take measurements of loaded components. For example, the boot loader may measure a kernel executable before transferring control to the kernel executable. A Linux kernel contains a subsystem called the Integrity Measurement Architecture (IMA) that can be used to measure userspace executables. If a statistical program that is to be loaded into the TDMS is a native-code program, it gets measured when it is loaded, assuming that the IMA is present in the virtual machine. If a statistical program that is to be loaded into the TDMS is written using an interpreted language (e.g., Python or non-native bytecode e.g., Java) then the interpreter (or the virtual machine interpreting the bytecode) is extended to measure the loaded content and will extend a first PCRN using the taken measurement. A second PCRM can be reserved for these interpreters so that these measurements do not extend the same PCR as the IMA. The virtual machine may also maintain a measurement log of extend events. However, the measurement log does not have to be integrity protected.

In another example, a Requesting Party that is selling products wants to know more about their customers. The Requesting Party wants to know the locations (e.g., ZIP codes) of their customers and an average income of their customers in each ZIP code area. The end-goal might be to plan a location for a new shop. The shop could be located close to an area where there are many customers weighted by their purchasing power. Customers' income level can be used as a proxy for purchasing power. A survey might contain questions about a user's previously purchased items, which may allow a different and malicious organization to perform a re-identification of the customers who participate in the organization's survey.

The Requesting Party creates a campaign survey, which is advertised in a bulletin board of the Marketplace. The Requesting Party also requests creation of a trusted active mailbox containing a program to analyze replies to the survey. The Requesting Party also publishes a signed manifest to the bulletin board that describes what kind of information is to be collected by the survey, what kind of statistical operations are to be conducted with the data, and what compensation is offered. As an incentive (i.e., form of compensation) for participating in the survey, each participating user is promised a lottery ticket. Users with winning lottery tickets are awarded $1000. Although lottery participation is a quite modest reward, the Responding Agent may determine that the associated user should participate in this survey. In a different example, users with winning lottery tickets are awarded gift baskets comprising an assortment of some of the organization's products.

The Requesting Party may post links to the source code of the analysis program and an SHA1 hash of the executable performing the analysis. Furthermore, the analysis program may be a standard operation that is already trusted and certified by the Marketplace. The bulletin board advertisement contains the RSA public key of the trusted active mailbox and a connection address for the mailbox.

The survey assertion can be an XML document describing (i) the type of data requested and (ii) the operations that are to be conducted. The following is an example of an XML document describing (i) the type of data requested and (ii) the operations that are to be conducted:

```
<request samplesize=5000>
  <data> PARAMETER x = schema.org::Person.income </data>
  <data> PARAMETER y = schema.org::Person.address.zipcode </data>
</request>
<reward type=”lottery”>
  <amount probability=0.001>$1000</amount>
</reward>
<process>
  <foreach id=”y”, require=”N >= 5”>
  <calculate>PARAMETER z</calculate>
    <calculate><z = AVG(x[0]..x[N])</calculate>
  <calculate>return y,z,N</calculate>
  </foreach>
</process>
```

The survey shown in this example requests a sample size of 5000 customers. Only ZIP code areas having at least five customers are taken into account when performing the averaging operation. The output of the code is a list including each zip code with at least 5 customers represented as: zip code, average income of customers in that zip code, number of customers in that zip code.

The Responding Agent detects the campaign survey that was posted by the Requesting Party. In some embodiments, the detection of the campaign survey is performed by operating the Responding Agent to periodically check the bulletin board. In some embodiments, the detection of the campaign survey is performed then the Responding Agent receives a notification regarding the new survey. The Responding Agent evaluates the signed manifest and detects that the user associated with the agent belongs to the target group (e.g., the user is a past customer of the organization according to a purchase history available to the Responding Agent). The Responding Agent determines whether the promised compensation reward is adequate. This determination may be based on a type of compensation (e.g., lottery ticket, cash payout), an expected value of the compensation, and a level anonymity (e.g., k-anonymity, l-diversity, t-closeness, etc.) guaranteed by the particular analysis to be performed. In some embodiments, the Responding Agent determines the level anonymity based at least in part on the existing user base that has already agreed to participate in the survey.

After determining that the user associated with the Responding Agent should participate in this survey, the Responding Agent implants the requested information into a message and encrypts this message using the RSA public key of the trusted active mailbox, signs the message, and sends it to the trusted active mailbox. The trusted active mailbox verifies the signature, decrypts the message, and in doing so retrieves the requested data. The trusted active mailbox then sends lottery participation data to the Responding Agent. In this exemplary embodiment, the trusted active mailbox remains open until it collects 5000 response messages. After receiving all of these messages, the trusted active mailbox performs a calculation of the average income in each ZIP code area. ZIP code areas that have less than five response messages are left out from the survey. Results (e.g. a set of tuples including ZIP code, average income, and number of customers) are then returned to the Requesting Party by the trusted active mailbox.

The Requesting Party can then post-process the results in order to identify areas (ZIP codes) that have large numbers of customers and lack a nearby shop. Potential shop location candidates may then be prioritized based on customers' average income value, which can be considered to be a proxy for purchasing power.

Embodiments of the trusted active mailbox allow different individuals represented by Responding Agents to seek different levels of anonymity. For example, each user may set a predetermined anonymity threshold for different types of user data. The anonymity threshold may be, for example, a minimum number of users, with a user declining to provide his user data unless that user data is to be consolidated (e.g. averaged) in a pool containing at least the minimum number of users. Other types of anonymity threshold may also be used, such as k-anonymity, l-diversity, and t-closeness. A trusted active mailbox may operate to evaluate a level of anonymity (e.g. k-anonymity, l-diversity, t-closeness, or some combination of these) that would result from a data processing calculation and may allow a user's data to be included in the calculation results only if the level of evaluated level of anonymity meets or exceed the user's individual anonymity threshold.

A trusted active mailbox may use one or more of several different techniques to determine whether to incorporate a particular user's data in a consolidated set of data provided to a Requesting Party. The trusted active mailbox may store anonymity thresholds for each user, for example in a database. The anonymity thresholds may be configured in advance by the users or may be received along with user data in response to a request for user information.

A determination of which users' data is included in processed data may be performed iteratively. For example, a first set of survey participants may be identified, for example a set of users having a low anonymity threshold. A level of anonymity is determined for processed data based on the initial set of survey participants. If the level of anonymity exceeds the anonymity thresholds of the first set of survey participants, the first set of survey participants are included in a confirmed set of survey participants. Other potential survey respondents may then be selected, with the potential survey respondents having an anonymity threshold below the determined level of anonymity. A new level of anonymity is determined with the addition of the other potential survey respondents. Given the additional respondents, the newly determined level of anonymity is likely to be higher than the previous level, and additional potential survey respondents with higher anonymity thresholds can be added. In such a way, users can be added iteratively to a list of confirmed survey respondents to ensure that the level of anonymity meets the requirements of the different respondents. Potential participants can be added until a minimum or maximum number of participants set by the Requesting Party have been confirmed as participants.

In another method of selecting participants, a first test level of anonymity is set, and a first set of participants is selected based on their willingness to share data at the first test level of anonymity. A first calculated level of anonymity is determined based on the first set of participants. If the first calculated level of anonymity is at or above the first test level of anonymity, then the first set of participants is a valid set of participants and can be used to provide processed data to a Requesting Party, provided other requirements (e.g. minimum and maximum numbers of participants) are met. If the first calculated level of anonymity is not at or above the first test level of anonymity, the set is not a valid set and is not used to provide processed data to Requesting Parties.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

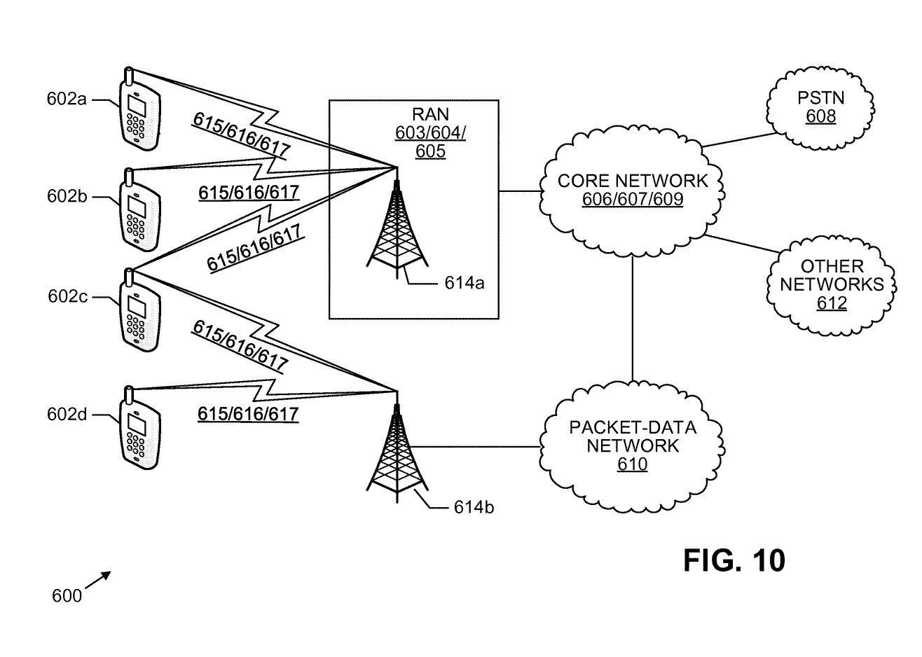

FIG. 10 is a diagram of an example communications system 600 in which one or more disclosed embodiments may be implemented. The communications system 600 may be a multiple access system that provides content, such as voice, data, video, messaging, broadcast, and the like, to multiple wireless users. The communications system 600 may enable multiple wireless users to access such content through the sharing of system resources, including wireless bandwidth. For example, the communications systems 600 may employ one or more channel-access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 10, the communications system 600 may include WTRUs 602a, 602b, 602c, and/or 602d (which generally or collectively may be referred to as WTRU 602), a RAN 603/604/605, a core network 606/607/609, a public switched telephone network (PSTN) 608, a packet data network 610, such as the Internet, and other networks 612, though it will be appreciated that the disclosed embodiments contemplate any number of WTRUs, base stations, networks, and/or network elements. Each of the WTRUs 602a, 602b, 602c, 602d may be any type of device configured to operate and/or communicate in a wireless environment. By way of example, the WTRUs 602a, 602b, 602c, 602d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 600 may also include a base station 614a and a base station 614b. Each of the base stations 614a, 614b may be any type of device configured to wirelessly interface with at least one of the WTRUs 602a, 602b, 602c, 602d to facilitate access to one or more communication networks, such as the core network 606/607/609, the Internet 610, and/or the networks 612. By way of example, the base stations 614a, 614b may be a base transceiver station (BTS), a Node-B, an eNode B, a Home Node B, a Home eNode B, a site controller, an access point (AP), a wireless router, and the like. While the base stations 614a, 614b are each depicted as a single element, it will be appreciated that the base stations 614a, 614b may include any number of interconnected base stations and/or network elements.

The base station 614a may be part of the RAN 603/604/605, which may also include other base stations and/or network elements (not shown), such as a base station controller (BSC), a radio network controller (RNC), relay nodes, and the like. The base station 614a and/or the base station 614b may be configured to transmit and/or receive wireless signals within a particular geographic region, which may be referred to as a cell (not shown). The cell may further be divided into sectors. For example, the cell associated with the base station 614a may be divided into three sectors. Thus, in one embodiment, the base station 614a may include three transceivers, i.e., one for each sector of the cell. In another embodiment, the base station 614a may employ multiple-input multiple output (MIMO) technology and, therefore, may utilize multiple transceivers for each sector of the cell.

The base stations 614a, 614b may communicate with one or more of the WTRUs 602a, 602b, 602c, 602d over an air interface 615/616/617, which may be any suitable wireless communication link (e.g., radio frequency (RF), microwave, infrared (IR), ultraviolet (UV), visible light, and the like). The air interface 615/616/617 may be established using any suitable radio access technology (RAT).

As noted above, the communications system 600 may be a multiple access system and may employ one or more channel-access schemes, such as CDMA, TDMA, FDMA, OFDMA, SC-FDMA, and the like. For example, the base station 614a in the RAN 603/604/605 and the WTRUs 602a, 602b, 602c may implement a radio technology such as Universal Mobile Telecommunications System (UMTS) Terrestrial Radio Access (UTRA), which may establish the air interface 615/616/617 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 614a and the WTRUs 102a, 102b, 102c may implement a radio technology such as Evolved UMTS Terrestrial Radio Access (E UTRA), which may establish the air interface 615/616/617 using Long Term Evolution (LTE) and/or LTE Advanced (LTE A).

In other embodiments, the base station 614a and the WTRUs 602a, 602b, 602c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS 2000), Interim Standard 95 (IS 95), Interim Standard 856 (IS 856), Global System for Mobile communications (GSM), Enhanced Data rates for GSM Evolution (EDGE), GSM EDGE (GERAN), and the like.

The base station 614b in FIG. 10 may be a wireless router, Home Node B, Home eNode B, or access point, as examples, and may utilize any suitable RAT for facilitating wireless connectivity in a localized area, such as a place of business, a home, a vehicle, a campus, and the like. In one embodiment, the base station 614b and the WTRUs 602c, 602d may implement a radio technology such as IEEE 802.11 to establish a wireless local area network (WLAN). In another embodiment, the base station 114b and the WTRUs 602c, 602d may implement a radio technology such as IEEE 802.15 to establish a wireless personal area network (WPAN). In yet another embodiment, the base station 614b and the WTRUs 602c, 602d may utilize a cellular-based RAT (e.g., WCDMA, CDMA2000, GSM, LTE, LTE-A, and the like) to establish a picocell or femtocell. As shown in FIG. 10, the base station 614b may have a direct connection to the Internet 610, shown here as a packet-data network. Thus, the base station 614b may not be required to access the Internet 610 via the core network 606/607/609.

The RAN 603/604/605 may be in communication with the core network 606/607/609, which may be any type of network configured to provide voice, data, applications, and/or voice over internet protocol (VoIP) services to one or more of the WTRUs 602a, 602b, 602c, 602d. As examples, the core network 606/607/609 may provide call control, billing services, mobile location-based services, pre-paid calling, Internet connectivity, video distribution, and the like, and/or perform high-level security functions, such as user authentication. Although not shown in FIG. 10, it will be appreciated that the RAN 603/604/605 and/or the core network 606/607/609 may be in direct or indirect communication with other RANs that employ the same RAT as the RAN 603/604/605 or a different RAT. For example, in addition to being connected to the RAN 603/604/105, which may be utilizing an E-UTRA radio technology, the core network 606/607/609 may also be in communication with another RAN (not shown) employing a GSM radio technology.

The core network 606/607/609 may also serve as a gateway for the WTRUs 602a, 602b, 602c, 602d to access the PSTN 608, the Internet 610, and/or other networks 612. The PSTN 608 may include circuit-switched telephone networks that provide plain old telephone service (POTS). The Internet 610 may include a global system of interconnected computer networks and devices that use common communication protocols, such as the transmission control protocol (TCP), user datagram protocol (UDP) and IP in the TCP/IP Internet protocol suite. The networks 612 may include wired and/or wireless communications networks owned and/or operated by other service providers. For example, the networks 612 may include another core network connected to one or more RANs, which may employ the same RAT as the RAN 603/604/605 or a different RAT. In various examples, the Marketplace and/or Requesting Parties may be implemented using one or more servers disposed in communication with one or more base stations

Some or all of the WTRUs 602a, 602b, 602c, 602d in the communications system 600 may include multi-mode capabilities, i.e., the WTRUs 102a, 102b, 102c, 102d may include multiple transceivers for communicating with different wireless networks over different wireless links. For example, the WTRU 602c shown in FIG. 10 may be configured to communicate with the base station 614a, which may employ a cellular-based radio technology, and with the base station 614b, which may employ an IEEE 802 radio technology.

In some embodiments, the systems and methods, such as those described in connection with the Responding Agent, may be implemented in the WTRUs, such as WTRU 602 illustrated in FIG. 10. For example, a Responding Agent may be implemented using one or more software modules on a WTRU.

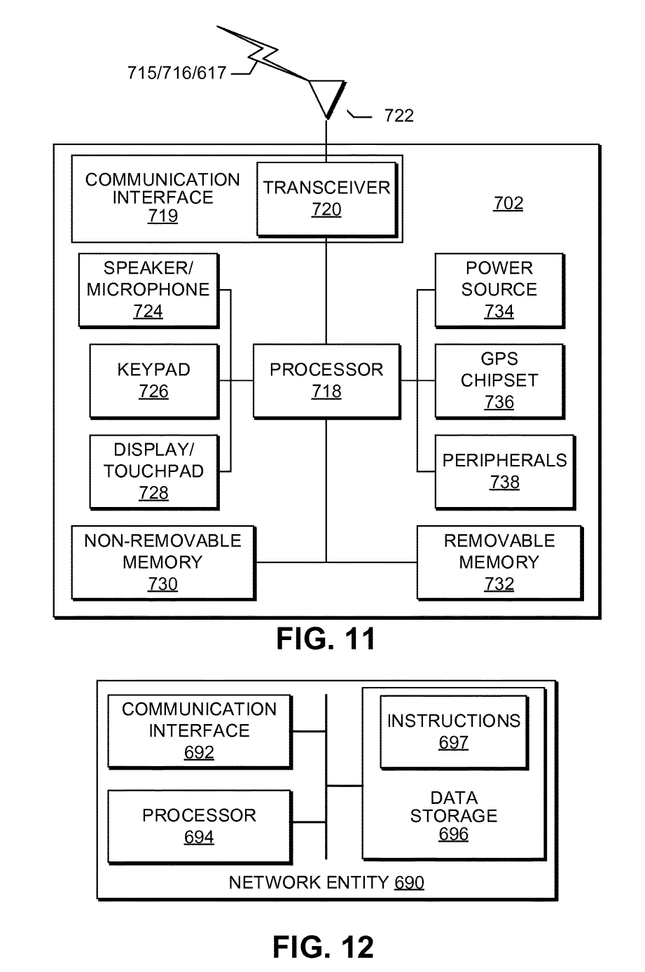

As shown in FIG. 11, the WTRU 702 may include a processor 718, a transceiver 720, a transmit/receive element 722, audio transducers 724 (preferably including at least two microphones and at least two speakers, which may be earphones), a keypad 726, a display/touchpad 728, a non-removable memory 730, a removable memory 732, a power source 734, a global positioning system (GPS) chipset 736, and other peripherals 738. It will be appreciated that the WTRU 702 may include any sub-combination of the foregoing elements while remaining consistent with an embodiment. The WTRU may communicate with nodes such as, but not limited to, base transceiver station (BTS), a Node-B, a site controller, an access point (AP), a home node-B, an evolved home node-B (eNodeB), a home evolved node-B (HeNB), a home evolved node-B gateway, and proxy nodes, among others.

The processor 718 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 718 may perform signal coding, data processing, power control, input/output processing, and/or any other functionality that enables the WTRU 702 to operate in a wireless environment. The processor 718 may be coupled to the transceiver 720, which may be coupled to the transmit/receive element 722. While FIG. 11 depicts the processor 718 and the transceiver 720 as separate components, it will be appreciated that the processor 718 and the transceiver 720 may be integrated together in an electronic package or chip.

The transmit/receive element 722 may be configured to transmit signals to, or receive signals from, a node over the air interface 715. For example, in one embodiment, the transmit/receive element 722 may be an antenna configured to transmit and/or receive RF signals. In another embodiment, the transmit/receive element 722 may be an emitter/detector configured to transmit and/or receive IR, UV, or visible light signals, as examples. In yet another embodiment, the transmit/receive element 722 may be configured to transmit and receive both RF and light signals. It will be appreciated that the transmit/receive element 722 may be configured to transmit and/or receive any combination of wireless signals.

In addition, although the transmit/receive element 722 is depicted in FIG. 11 as a single element, the WTRU 702 may include any number of transmit/receive elements 722. More specifically, the WTRU 702 may employ MIMO technology. Thus, in one embodiment, the WTRU 702 may include two or more transmit/receive elements 722 (e.g., multiple antennas) for transmitting and receiving wireless signals over the air interface 715.

The transceiver 720 may be configured to modulate the signals that are to be transmitted by the transmit/receive element 722 and to demodulate the signals that are received by the transmit/receive element 722. As noted above, the WTRU 702 may have multi-mode capabilities. Thus, the transceiver 720 may include multiple transceivers for enabling the WTRU 702 to communicate via multiple RATs, such as UTRA and IEEE 802.11, as examples.

The processor 718 of the WTRU 702 may be coupled to, and may receive user input data from, the audio transducers 724, the keypad 726, and/or the display/touchpad 728 (e.g., a liquid crystal display (LCD) display unit or organic light-emitting diode (OLED) display unit). The processor 718 may also output user data to the speaker/microphone 724, the keypad 726, and/or the display/touchpad 728. In addition, the processor 718 may access information from, and store data in, any type of suitable memory, such as the non-removable memory 730 and/or the removable memory 732. The non-removable memory 730 may include random-access memory (RAM), read-only memory (ROM), a hard disk, or any other type of memory storage device. The removable memory 732 may include a subscriber identity module (SIM) card, a memory stick, a secure digital (SD) memory card, and the like. In other embodiments, the processor 718 may access information from, and store data in, memory that is not physically located on the WTRU 702, such as on a server or a home computer (not shown).

The processor 718 may receive power from the power source 734, and may be configured to distribute and/or control the power to the other components in the WTRU 702. The power source 734 may be any suitable device for powering the WTRU 702. As examples, the power source 734 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 618 may also be coupled to the GPS chipset 636, which may be configured to provide location information (e.g., longitude and latitude) regarding the current location of the WTRU 702. In addition to, or in lieu of, the information from the GPS chipset 736, the WTRU 702 may receive location information over the air interface 715 from a base station and/or determine its location based on the timing of the signals being received from two or more nearby base stations. It will be appreciated that the WTRU 702 may acquire location information by way of any suitable location-determination method while remaining consistent with an embodiment.

The processor 718 may further be coupled to other peripherals 738, which may include one or more software and/or hardware modules that provide additional features, functionality and/or wired or wireless connectivity. For example, the peripherals 738 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 12 depicts an example network entity 690 that may be used within the communication system 600 of FIG. 1A. As depicted in FIG. 12, network entity 690 includes a communication interface 692, a processor 694, and non-transitory data storage 696, all of which are communicatively linked by a bus, network, or other communication path 698. Executable code for the Responding Agent may be stored, for example, in the non-transitory data storage 696.

Communication interface 692 may include one or more wired communication interfaces and/or one or more wireless-communication interfaces. With respect to wired communication, communication interface 692 may include one or more interfaces such as Ethernet interfaces, as an example. With respect to wireless communication, communication interface 692 may include components such as one or more antennae, one or more transceivers/chipsets designed and configured for one or more types of wireless (e.g., LTE) communication, and/or any other components deemed suitable. And further with respect to wireless communication, communication interface 692 may be equipped at a scale and with a configuration appropriate for acting on the network side—as opposed to the client side—of wireless communications (e.g., LTE communications, Wi Fi communications, and the like). Thus, communication interface 692 may include the appropriate equipment and circuitry (perhaps including multiple transceivers) for serving multiple mobile stations, UEs, or other access terminals in a coverage area.

Processor 694 may include one or more processors of any type deemed suitable, some examples including a general-purpose microprocessor and a dedicated DSP. Data storage 696 may take the form of any non-transitory computer-readable medium or combination of such media, some examples including flash memory, read-only memory (ROM), and random-access memory (RAM) to name but a few, as any one or more types of non-transitory data storage deemed suitable could be used. As depicted in FIG. 12, data storage 696 contains program instructions 697 executable by processor 694 for carrying out various combinations of the various network-entity functions described herein.

In some embodiments, one or more of such functions of, for example, the Marketplace and Requesting Parties, are carried out by a set of multiple network entities in combination, where each network entity has a structure similar to that of network entity 690 of FIG. 12. In various different embodiments, network entity 690 is—or at least includes—one or more of (one or more entities in) RAN 603, (one or more entities in) RAN 604, (one or more entities in) RAN 605, (one or more entities in) core network 606, (one or more entities in) core network 607, (one or more entities in) core network 609, base station 614a, base station 614b, and/or the like. Other network entities and/or combinations of network entities could be used in various embodiments for carrying out the network-entity functions described herein, as the foregoing list is provided by way of example and not by way of limitation.

Although features and elements are described above in particular combinations, it will be appreciated that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, digital versatile disks (DVDs) and Blu-ray disks. A processor in association with software may be used to implement a radio frequency transceiver for use in a WTRU, UE, terminal, base station, RNC, or any host computer.

In the foregoing specification, specific embodiments have been described. However, it is understood that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

1-20. (canceled)

21. A method performed by an electronic marketplace, the method comprising:
publishing a request for user data;
in response to the published request, receiving respective user data from a plurality of responding agents, each of the responding agents having an associated anonymity threshold value;
from among the responding agents, determining a set of confirmed participants such that an anonymity value for processed data associated with the set of confirmed participants exceeds the associated anonymity threshold values of all responding agents included in the set of confirmed participants;
generating processed user data based only on the set of confirmed participants; and
sending the processed data to a requesting party.

22. The method of claim 21, wherein the electronic marketplace includes a database storing the respective anonymity threshold value for each of a plurality of responding agents, and wherein determining the set of confirmed participants comprises:
comparing the stored anonymity threshold value for each of a plurality of responding agents with the anonymity value for processed data associated with the set of confirmed participants.

23. The method of claim 21, wherein the anonymity value is a metric selected from the group consisting of k-anonymity, l-diversity, and t-closeness.

24. The method of claim 21, wherein determining the set of confirmed participants comprises:
identifying a first set of participants from among the responding agents;
determining an anonymity value for processed data associated with the first set of participants;
in response to a determination that the anonymity value exceeds the anonymity threshold values of all responding agents included in the first set of participants, including the first set of participants in the set of confirmed participants.

25. The method of claim 24, further comprising iteratively:
identifying an additional set of participants from among the responding agents having anonymity threshold values below they anonymity value;
including the additional set of participants in the set of confirmed participants to generate an updated set of confirmed participants; and
generating an updated anonymity value based on the updated set of confirmed participants.

26. The method of claim 25, wherein the additional participants are added until a set minimum number of participants are included in the set of confirmed participants.

27. The method of claim 25, wherein the additional participants are added until a set maximum number of participants are included in the set of confirmed participants.

28. The method of claim 21, wherein determining the set of confirmed participants comprises:
setting a test level of anonymity;
identifying a test set of participants from among the responding agents having anonymity thresholds below the test level of anonymity;
calculating an anonymity value for processed data associated with the test set of participants;
comparing the calculated anonymity value to the test level of anonymity; and
using the test set of participants as the set of confirmed participants only if the calculated anonymity value is greater than the test level of anonymity.

29. The method of claim 28, wherein the test set of participants is used as the set of confirmed participants only if the number of participants in the test set is at least a set minimum number.

30. The method of claim 28, wherein the test set of participants is used as the set of confirmed participants only if the number of participants in the test set is no greater than a set maximum number.

31. A system comprising an electronic marketplace server configured to perform functions comprising:
publishing a request for user data;
in response to the published request, receiving respective user data from a plurality of responding agents, each of the responding agents having an associated anonymity threshold value;
from among the responding agents, determining a set of confirmed participants such that an anonymity value for processed data associated with the set of confirmed participants exceeds the associated anonymity threshold values of all responding agents included in the set of confirmed participants;
generating processed user data based only on the set of confirmed participants; and
sending the processed user data to a requesting party.

32. The system of claim 31, wherein the electronic marketplace server further includes a database storing the respective anonymity threshold value for each of a plurality of responding agents, and wherein the marketplace server is further operative to determine the set of confirmed participants by comparing the stored anonymity threshold value for each of a plurality of responding agents with the anonymity value for processed data associated with the set of confirmed participants.
